(19) United States
(12) Patent Application Publication
(10) Pub. No.: US 2010/0278312 A1
(43) Pub. Date: Nov. 4, 2010

(54) CORE MEASUREMENTS STAND FOR USE WITH A PORTABLE XRF ANALYZER

(75) Inventor: Joseph D. Ortiz, Hudson, OH (US)

Correspondence Address: FAY SHARPE LLP, 1228 Euclid Avenue, 5th Floor, The Halle Building, Cleveland, OH, 44115, US

(73) Assignee: Kent State University

(21) Appl. No.: 12/769,892

(22) Filed: Apr. 29, 2010

Related U.S. Application Data
(60) Provisional application No. 61/174,182, filed on Apr. 30, 2009.

(51) Int. Cl. H05G 1/02

(52) U.S. Cl. 378/195

(57) ABSTRACT

A support stand for an associated handheld analyzer is used to measure properties of an associated soil sample. The stand includes a shield situated in a first plane above an associated soil sample, a platform opening in the shield, a support platform moveable relative to the platform opening, and a mechanism to move the platform relative to the shield along an axis substantially perpendicular to the first plane. The platform supports the associated analyzer above the associated soil sample such that the associated analyzer can move relative to the associated soil sample.

### STATEMENT REGARDING FEDERALLY SPONSORED RESEARCH OR DEVELOPMENT

This invention was made with government support under NSF ARC-0612384 from the National Science Foundation. The government has certain rights in this invention.

### BACKGROUND

This is application claims priority to U.S. Provisional Application Ser. No. 61/174,182, filed Apr. 30, 2009, entitled “Core Measurements Stand for Use with a Portable Analyzer”, by Joseph D. Ortiz, the disclosure of which is hereby incorporated by reference in its entirety.

The present disclosure is related to a support stand for a handheld analyzer and, more specifically, to a support stand that can move the analyzer relative to a moving or a stationary sample.

X-ray fluorescence (XRF) analyzers are measurement systems that aid users in locating areas of special interest in a core sample. More specifically, XRF analyzers provide methods of irradiating samples to detect a presence of specific elements. An early XRF analyzer was introduced for lead paint analysis, but later instruments were developed for analysis of heavy metals in soils, and, for example, magnesium, aluminum, silicon, phosphorus, metal alloys, sulfur in metal alloys, and combinations thereof. These analyzers were situated in laboratory settings and required that a soil sample be transported to the laboratory for purposes of a time-delayed analysis.

Later models of XRF analyzers were developed to include portable handheld systems capable of performing analyses in real-time. The portable handheld analyzers were adapted for transport to exploration locations such that on-site measurements of drill cores and rock faces were made possible. The portable analyzer was able to aid, for example, in ore-grade assessments for blasting, excavation, and hauling activities, in assessing sites contaminations for hazardous substances, and in archaeology, including tasks in reconnaissance surveying, excavation site mapping, or artifact provenance.

Instrument platforms are portable test stands that provide on-site analysis capabilities for small and irregularly shaped samples. An existing portable test stand 100, known as the ThermoScientific SmartStand for use with the NITON® XL3 Series, is shown in FIG. 1 and includes a pair of collapsible legs 112 that support a generally horizontal platform 114. The platform 114 includes a sample insert 116 to precisely position samples for repeatable testing. A cover 118 pivots relative to the platform and closes over the sample. The cover 118 is shielded to prevent radiation exposure. A docking station 120, i.e., a cradle, is suspended from an undersurface of the platform 114 to support an XRF analyzer 122. The docking station 120 orients the XRF analyzer 122 such that the front end of analyzer faces upwardly toward the platform 114. The XRF analyzer 122 irradiates the sample on the platform 114. In this manner, a touch screen display 124 faces outward and is viewable by the user.

An XRF analyzer 200 is received in the instrument platform as shown with reference to FIG. 2. The XRF analyzer 200 shown is representative of the INNOV-X ALPHA™ handheld analyzer marketed by Innov-X systems and includes a rugged metal front end 210 (free of radioactive materials), an angled (or a linear) body portion 212, and a handle 214. The angled body portion 212 includes the front end 210, a rear surface 216, a top surface 218, an undersurface 220, and two opposing side surfaces 222. The handle 214 protrudes outwardly from the undersurface 220. An angled color touch-screen display 224 is situated on the top surface 218 for viewing of test results. The angled display 224 may be a removable PDA, in which case the top surface 218 includes a socket for surface mounting of the PDA, or still other display devices that provide viewing capabilities.

Typically, a user holds the XRF analyzer by grasping the handle 214 and by directing or pointing the front end 210 of the XRF analyzer 200 away from his or her person and toward the core sample. Primary X-rays are emitted from the front end 210 when the XRF analyzer 200 is pointed toward a sample and a touch trigger 223 is depressed. The unique secondary x-ray energies characteristic to elements in the sample are also detected at the front end 210. The XRF analyzer 200 identifies the element and defines a concentration of that element within the sample. The identification and concentration results are viewable in real-time on the display 224. As the user holds the XRF analyzer 200 such that its front end 210 is pointed outward, the user can view the data overhead on the angled display 224.

In existing instrument platforms, the XRF analyzer is supported in a fixed orientation in a docking station. FIG. 1 shows the existing instrument platform 100 having two support legs 112 that rest on a ground surface. The platform 114 is supported above the ground surface. The docking station 122 is situated between the platform 114 and the ground surface. The docking station cradles the XRF analyzer 124 such that its front end 210 (refer to FIG. 2) is pointed upwardly toward the platform 114, its rear surface 216 faces downwardly toward the ground surface, its handle faces outwardly, and its display 124/224 faces inwardly toward the user.

The existing instrument platform has some deficiencies when used in compliance screening, mining, archaeological research, and sedimentology. A first disadvantage is that the instrument platform can only irradiate small samples that are capable of being supported on the platform. A cross-sectional area of the platform is not much greater than the greatest cross-sectional area of the XRF analyzer (as shown in FIG. 1); hence, testing of samples is limited to a range of sample sizes.

A soil foot (not shown), which is a plastic attachment that secures to a front end of the XRF analyzer, supports an analyzer and allows the analyzer to point downwardly to irradiate a sample surface. The foot includes a pair of extending feet, which each extend generally parallel to the sample surface being analyzed. These feet are also generally parallel to a handle of the XRF analyzer. A disadvantage associated with the soil foot is an inability to rest on soft surfaces. Softer surfaces deform in response to instrument weight making the device unstable.

Another disadvantage associated both with existing platforms and soil feet is that there exists no adjustment means to move the XRF analyzer relative to the sample; rather, the XRF analyzer is supported at a fixed distance between the front end of the analyzer and the sample to be irradiated.

There exists a need for an instrument platform that is both capable of supporting a portable XRF analyzer on a wide variety of terrain and capable of providing the XRF analyzer with means for irradiating samples of a wide range of sizes.

### BRIEF DESCRIPTION

A first exemplary embodiment of the present disclosure provides a support stand for an associated handheld analyzer used to measure properties of an associated soil sample. The support stand includes a shield situated in a first plane above an associated soil sample, a platform opening in the shield, a support platform moveable relative to the platform opening, and a mechanism that moves the platform relative to the shield along an axis substantially perpendicular to the first plane. The platform supports the associated analyzer above the associated soil sample such that the associated analyzer can move relative to the associated soil sample to measure the associated soil sample.

A second exemplary embodiment of the present disclosure provides a portable core measurement stand for use with an associated portable scanner for measuring split-core samples in the field. The portable core measurement stand includes a shield with an opening therein, a platform moveable relative to the shield opening and having a conformation for supporting the associated portable scanner, and an adjustment mechanism for moving the platform relative to a first shield axis. The shield includes a surface supported by first and second spaced legs.

A third exemplary embodiment of the present disclosure provides an instrument platform for use with an associated portable XRF analyzer. The instrument platform includes a horizontal shield supported by downwardly extending legs, a lifting mechanism secured to an upper surface of the horizontal shield, a translating member secured to the lifting mechanism; and, a platform secured to the translating member. The platform is moveable along a vertical axis through an opening in the horizontal shield. The platform supports the associated portable XRF analyzer such that the associated portable XRF analyzer can take measurements of a soil sample situated underneath the horizontal shield.

One advantage associated with the present disclosure is a capability for positioning of the handheld analyzer above soil and core samples.

Another advantage associated with the present disclosure is a capability for adjusting a position of the handheld analyzer relative to the soil and core samples. The present disclosure provides an instrument platform capable of providing the handheld analyzer with a capability of making physical contact with the sample, while its shield aspects still protects the user from irradiation. Another advantage associated with the height adjustment means is that the handheld analyzer is capable of being supported at a height above the shield.

An additional advantage associated with the present disclosure is a capability of taking continuous measurements of samples, and thus a reduction in the steps required to process the sample. The measurements can be taken on site where there is simultaneous, active drilling of material.

A further advantage associated with the present disclosure is an increased range in the size of samples of which the present instrument platform aids in analyses. The present support stand can be used to assist in measurements of sediment layers in lake cores samples, which may range in size between one millimeter (mm) and one centimeter (cm), in measurements of sediment layers in marine core samples, which similarly range in size between one mm and ten cm, and in measurements of layers in terrestrial rock cores, which may reach thicknesses of several meters. In other words, the present support stand is capable of being utilized in a wide variety of terrains and at a wide variety of work sites.

### BRIEF DESCRIPTION OF THE DRAWINGS

FIG. 1 is a front perspective view of a prior art instrument platform;

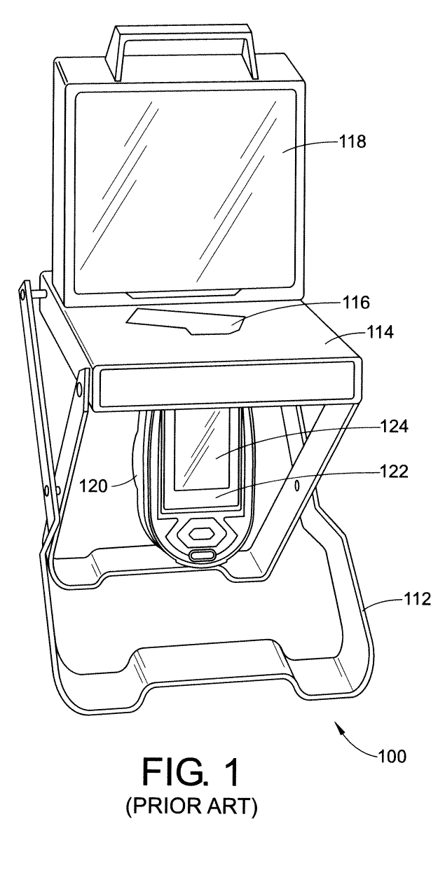

FIG. 2 is a side perspective view of a portable XRF analyzer for use with an instrument platform;

FIG. 3A is front perspective view of a support stand for a handheld analyzer according to one embodiment of the disclosure;

FIG. 3B is a front perspective view of a second embodiment for a support stand;

FIG. 4 is a cross-sectional view taken along line 4-4 of the support stand shown in FIG. 3;

FIG. 5 is a partial side perspective view of the support stand including a rotational adjustment means for rotating a support platform of FIG. 3; and,

FIG. 6 is a top view of the shield and supports portions of the support stand shown in FIG. 3.

### DETAILED DESCRIPTION

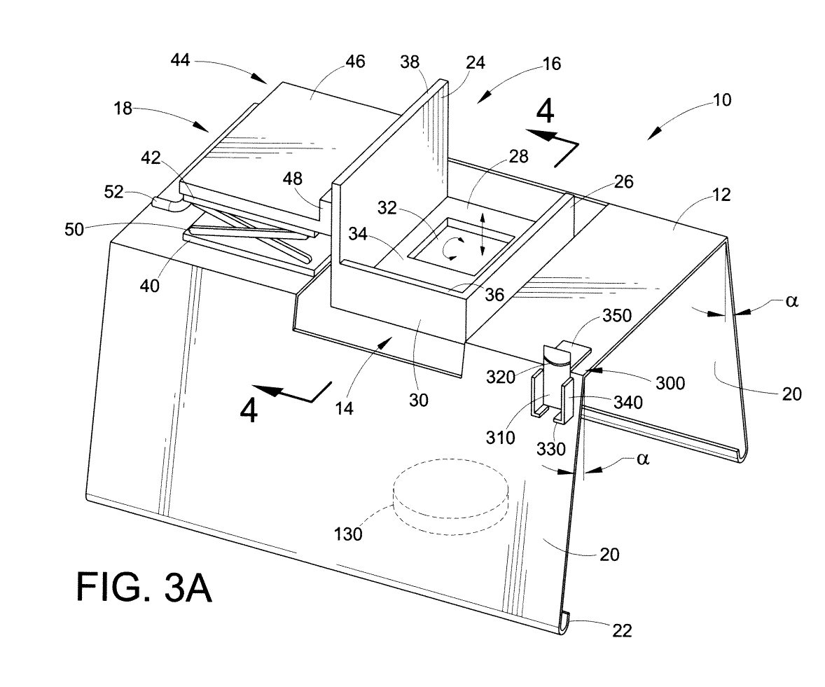

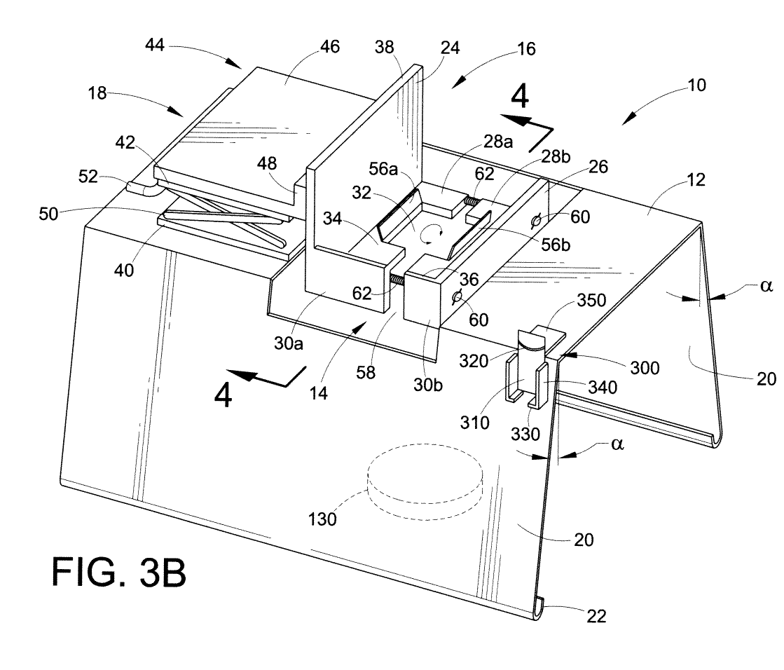

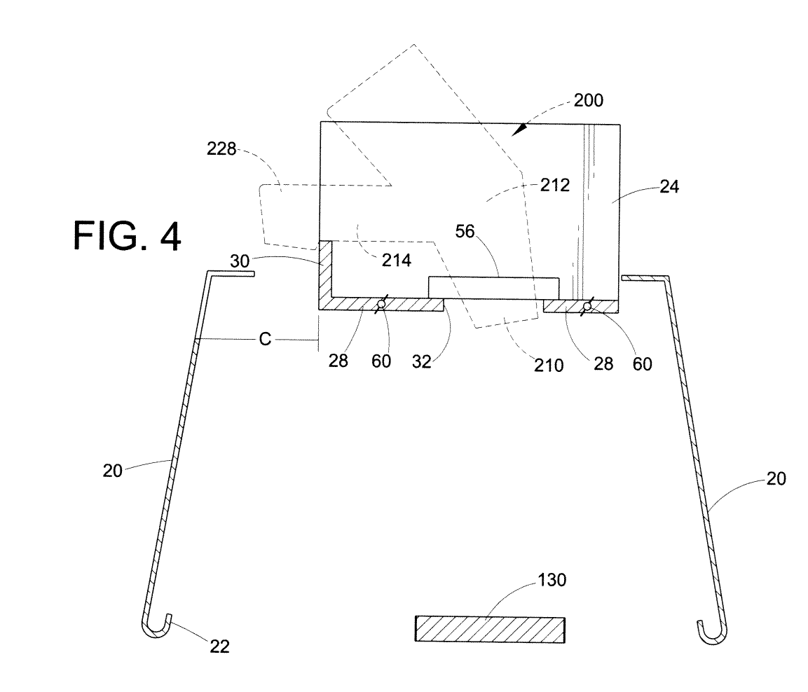

FIGS. 3 and 4 show one embodiment of a support stand 10 (synonymously referred to herein as an “instrument platform”), according to the present disclosure and for use with a handheld analyzer, which is used to measure properties of an associated soil sample. Among other distinctions associated with the present support stand 10 is the ability to change the orientation of the handheld analyzer. The combination of the scanner and stand of the present disclosure are capable of irradiating larger samples and selectively moving the handheld analyzer relative to the samples.

A side-elevational view of the support stand 10 is shown in FIG. 3. The stand 10 includes a shield 12 situated in a plane above a soil sample 130. This shield 12 is preferably formed of a material for attenuating radiation. High mass density materials, such as, for example, lead or steel, PVC radiation shields, and light-weight alloy alternatives, such as, for example, Xenolight-NL, are exemplary materials for the shield 12. In one embodiment, a PVC radiation shield is used to reduce an overall weight of the support stand 10. Weight limitations are a consideration for certain embodiments in which portability of the support stand is important.

The shield 12 is preferably a generally planar body and includes a shield opening 14 formed through the planar body. This shield opening 14 can be formed through any cross-sectional area of the shield 12. In the illustrated embodiment, the shield opening 14 extends along a limited length portion of the shield 12. The shield opening 14 can extend over a limited length of the shield 12 or the entire length, and likewise may extend across a portion of the width of the shield or over the entire width.

The shield opening 14 accommodates selective movement of a support platform 16 there through. The support platform 16 functions as a docking station to support the portable analyzer while advantageously permitting movement relative to the sample. In this manner, a distance between the handheld analyzer and the sample is adjustable.

The support platform 16 preferably moves relative to the shield 12 along an axis that is substantially perpendicular to the plane in which the shield 12 is situated. In the preferred embodiment, the shield 12 is generally oriented horizontally over the ground, and the support platform 16 moves along a generally vertical axis. The support stand 10 includes an adjustment mechanism or means 18 to selectively raise and lower the support platform 16 along the vertical axis.

In the preferred embodiment, the support platform 16 also selectively rotates relative to the shield 12 about a longitudinal axis that is substantially congruent with or parallel to the plane in which the shield 12 is situated. The adjustment mechanism 18 selectively rotates an orientation of the support platform 16 about the longitudinal axis of the shield 12 so that the angle of delivery of x-rays emitted from the analyzer can be selectively adjusted.

In the exemplary embodiment, the support stand 10 includes at least one support and, more preferably, at least one pair of opposing supports 20 extending from the shield 12 and supporting the shield above the ground surface and the soil sample. Each of the pair of supports 20 can extend along an entire longitudinal edge of the shield 12, although one skilled in the art will appreciate that the pair of supports 20 can extend along a limited length of the shield. Each of the pair of supports 20 is similarly manufactured from a material that attenuates radiation. Exemplary materials include high mass density materials, PVC materials, and light-weight alloy alternatives. The pair of supports 20 can be manufactured from the same or a different material than the shield 12, although in the preferred arrangement, the supports and shield are made of the same material.

A sample, i.e., a split-core material or a rock sample, is situated under the shield 12. The sample is sandwiched between the shield 12 and the ground and likewise between the pair of supports 20. In this manner, the x-rays emitted from the analyzer, and the irradiation emitted from the sample, are both contained by the x-ray impervious materials of the shield 12 and the supports 20.

There are at least two methods for situating a sample for testing underneath the shield 12. A first method includes placement of the support stand 10 on a surface and movement of the sample through at least one open end formed between the shield 12, the opposing supports 20, and the ground. The sample can be moved through the opening to a contained space underneath the handheld analyzer by any conveyor means (not shown). One advantage associated with the present support stand 10 is that the handheld analyzer can perform a series of tests on a plurality of samples continuously moving through the shield 12, wherein the conveyer means enters the space at the first open end 13 (to carry the sample) and exits the space at the opposite, second open end (not shown) of the stand 10.

The second method for situating a sample for testing underneath the shield is to place the support stand 10 over a stationary sample. The pair of supports 20 is capable of resting on leveled, unleveled, hard and soft, deformable surfaces. The pair of supports 20 elevates the shield to a preselected height above the sample. Selected supports 20 can penetrate into the soil and/or ground to provide stability for the stand on uneven soft surfaces. A bottom edge of the supports 20 can include an inward, flat fold to provide additional support to the instrument platform 10, although one skilled in the art can appreciate that there is a plurality of reinforcement means which can alternatively be utilized. For example, the bottom edge of each of the supports 20 can include an inward extending flange or lip 22 such that each of the pair of supports 20 fold inwardly and upwardly at their edges which contact the ground surface and can prevent the support stand 10 from deforming deep into soft surfaces.

In one embodiment, the support stand 10 can further include a second pair of opposing supports (not shown) also extending from the shield 12 and supporting the shield above the soil sample. Each of the second pair of supports can extend along an entire short-edge of the shield. It is to be noted herein however that the shield is not limited to any one polygonal structure having a cross-sectional area formed by any fixed number of edges that are defined by any relative lengths. One embodiment of the present support stand 10 can include any number of supports 20 that extend along an equal number of edges forming the shield 12, in which manner the supports (legs) form a completely enclosed sample containment space.

The supports 20 are preferably secured to the shield 12 at a fixed angle. The support stand 10 includes support legs 20 that extend outwardly from the shield 12 at an angle α of from about 90° to about 150° and more preferably at an angle of approximately 120°. Alternately, the supports 20 are pivotal about the edge of the shield 12 such that they can adjust to uneven terrain. In this embodiment, hinges (not shown) can be used to connect the pair of supports 20 to the shield 12 and thereby allow the supports to collapse for easy transport.

The support platform 16 includes a moveable body, which translates along the axis extending through the shield opening 14. The support platform 16 further includes a front wall 30 opposite a second sidewall 26 and an interconnecting wall 28 (“floor”) extending generally perpendicular thereto. The interconnecting wall 28 interconnects the first, second, and front walls 24, 26, 30 along their longitudinal edges. In one embodiment, a rear wall (not shown) can extend parallel to and opposite of the front wall 30, thus interconnecting first and second sidewalls 24, 26 along their generally vertical, lateral edges. The first sidewall 24 is operatively connected to the adjustment mechanism 18. The interconnecting wall 28 supports the handheld analyzer.

In the embodiment illustrated in FIG. 38, the front wall 30 and the interconnecting wall 28 (and a rear wall for embodiments including such) each include two halves, which are referred to herein as first and second front wall halves 30a, 30b and first and second interconnecting wall halves 28a, 28b. The first front wall half 30a is fixed to and extends perpendicularly outwardly from a lateral edge of the first sidewall 24. The first interconnecting half 38a is fixed to and extends perpendicularly outwardly from a longitudinal lower edge of the first sidewall 24. The second front wall and interconnecting halves 30b, 28b are laterally moveable toward and away from their respective counterparts.

In the embodiment of FIG. 3B, the second front wall and interconnecting halves 30b, 28b are laterally moveable toward and away from the first front wall and interconnecting halves 30a, 28a so that a pair of clamping arms 56a, 56b can adjust a grasp of the analyzer removeably supported in cavity 34.

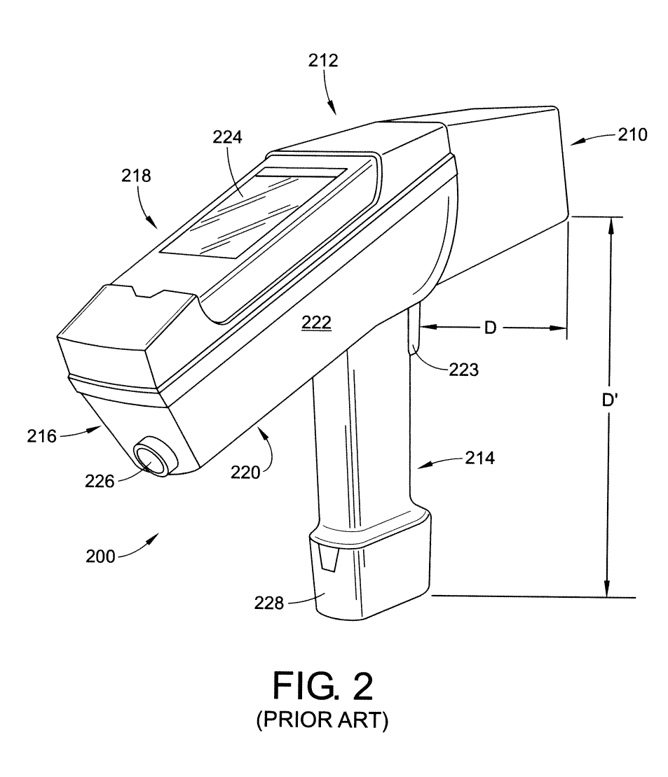

The first sidewall 24, the second sidewall 26, the front wall halves 30a, 30b, and the interconnecting wall halves 28a, 28b generally form the support cavity 34 which receives the analyzer. The analyzer is positioned within the support platform 16 to face downwardly with its front end 210 (see FIG. 2) directed toward the interconnecting wall 38. The handle 214 of the handheld analyzer rests on a top edge 36 of the front wall 30 of the support platform 16. Therefore, a height of the front wall 30 is preferably equal to or less than a distance D (FIG. 2) between the front end 210 of the handheld analyzer 200 and the handle 214. In some operations, however, the height is not limiting. Rather, the handle 214 of the handheld analyzer rests between a gap 58 (FIG. 3B) formed between the first and second front sidewalls 30a, 30b. A similar gap may be similarly formed between a pair of rear sidewall halves for embodiments including a rear sidewall. In the contemplated embodiment, the handle of the analyzer is oriented toward the front sidewall 30 or sidewall halves 30a, 30b. The interconnecting wall 28 (or interconnecting wall halves 30a, 30b) of the support platform 16 is a generally planar body that includes (or forms) a platform opening 32 therethrough. The platform opening 32 allows for transmission of x-rays to be directed toward the soil sample. This platform opening 32 is preferably situated on the interconnecting wall 28 at an end generally opposite to the front wall 30. The platform opening 32 is situated at a distance from the front wall 30 generally less than a distance D′ (see FIG. 2) from the inner edge of the front end 210 of the handheld analyzer and a butt end of the handle 214. In one embodiment, the platform opening 32 is situated at a distance from the front wall 30 generally equal to a distance D′ (for example, about four to five inches) between an inner edge of the front end 210 of the handheld analyzer 200 and the innermost portion of a battery compartment 228 at a terminal end of the handle 214. The platform opening 32 preferably includes a cross-sectional area generally equal to a cross-sectional area of the front end 210 of the handheld analyzer 200.

The clamping arms 56(a,b) are illustrated in FIGS. 3B to 5 as being generally planar, vertical walls extending upwardly from opposite edges of the platform opening 32; however, there is no limit made to a structure for the arms. More specifically, the clamping arms 56 extend upwardly from the opposite edges situated parallel to the first and second sidewalls 24, 26. In one embodiment, these clamping arms 56a, 56b are padded clamping arms, wherein a protective mechanism or material is included on at least a portion of an inner oriented surface on each clamping arm 56a, 56b. This protective mechanism protects the analyzer from incurring any cosmetic or more severe damage when the grasp is adjusted.

The clamping arms 56 securely grasp the analyzer so that there is no inadvertent shifting incurred by the analyzer during its periods of activation. The clamping arms 56 are capable of tightening and loosening a secure hold of the analyzer by laterally moving one clamping arm 56b relative to the other clamping arm 56a. Both clamping arms are fixed to their attachments. A first clamping arm 56a is attached to the first interconnecting portion 28a and, therefore, does not move positions. A second clamping arm 56b is attached to the second interconnecting portion and, therefore, moves with the second interconnecting portion 28a when the second interconnecting portion moves laterally toward and away from first sidewall 24.

Movement of the second interconnecting portion 28b and second front sidewall 30a (hereinafter referred together as second interconnecting portion 28a) is accomplished by adjustable mechanisms including, for example, thumb screws or similar fastener members. In the illustrated embodiment, at least one adjustable broad head 60 is situated on and/or accessible at an outer oriented surface of the second sidewall 26. In the illustrated embodiment, two thumb screws are utilized and, as such, two broad heads 60 are shown situated on opposite sides of the second sidewall 26. The broad heads 60 are turned to move the second interconnecting portion 28b about a threaded screw 62 connected to the broad heads. The screw 60 turns about a length portion of a threaded bore (not shown) that is included in at least one of the first or second interconnecting portions 28a, 28b.

FIG. 4 shows the support stand shown in FIG. 3. This cross-sectional illustration shows an orientation of the handheld analyzer 200 as received in the support platform 16. As is shown, the front end 210 of the handheld analyzer 200 is positioned such that it can direct x-rays through the platform opening 32. The handle 214 of the analyzer 200 rests on the top edge 32 of the front wall 30 of the platform 16. The battery compartment 228 of the handle 214, however, protrudes outwardly past the front wall 30.

For the support platform 16 (and analyzer) to properly move through the shield opening 14, the battery compartment 222 (i.e., the butt of the handle 214 for other analyzer models) cannot extend past the closer support 20 of the support stand 10. Therefore, in one embodiment, a clearance C exists between an outer surface of the front wall 30 and the inner surface of the support 20 to accommodate movement of the exposed handle 214 portion there between. The clearance C is dimensioned to be at least slightly greater than a distance between the inner edge of the front end 210 and the butt of the handle 214 of the analyzer minus the distance between the inner edge of the front end 210 and the outer facing surface of the front wall 30.

The support platform 16 can be formed of any of a plurality of materials. In one embodiment, the support platform 16 can be formed of an x-ray impervious material, which protects users from x-rays. In one embodiment, the support platform can be formed of wood, metal, PVC and other plastic materials, etc. The first sidewall 24, the second sidewall 26 and the connecting wall 28 can be formed from the same or different materials.

It is important to note that the support platform 16 is not limited to solely the size, shape, and dimensions provided herein; rather, it is anticipated that various other shaped support platforms 16 can be included with the herein disclosed instrument platform 10, which can equally and effectively support various models of analyzers. It is anticipated, for example, that one embodiment of a support platform 16 accommodate an analyzer removeably connected to a soil foot, in which case, the front wall 30 is absent to accommodate the feet of the soil foot attachment.

The adjustment mechanism or means 18 lifts and lowers the support platform 16 relative to the sample. The adjustment means 18 is operatively coupled to at least one of the first sidewall 24, the second sidewall 26, the interconnecting wall 28, and the front wall 30. In the embodiment shown in FIG. 3, the adjustment means 18 is secured to the outer surface of the first sidewall 24 of the support platform 16.

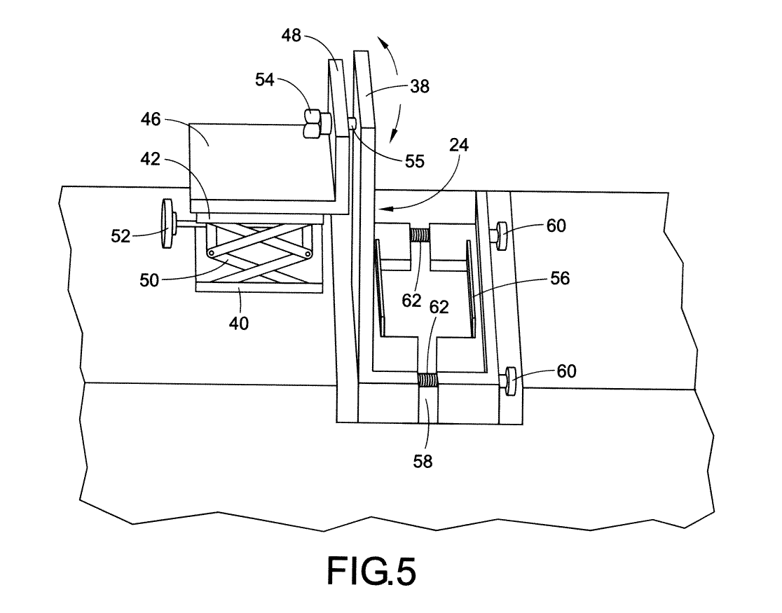

The adjustment means 18 is preferably situated above the first, outer surface of the shield 12. The adjustment means 18 includes a lower base member 40 operatively coupled to a top surface of the shield 12 and an upper base member 42 operatively coupled to an undersurface of a translating member 44. The adjustment means 18 includes a jackscrew 50 situated between the lower base and the upper base members 40, 42. A leadscrew 52 can be used to operate the jackscrew 50, which in turn actuates a raising and lowering of the translating member 44. The adjustment means 18 is not limited herein to utilization of a jackscrew; rather, any comparable lift mechanism is contemplated which is selectively operable to lift and lower the support platform 16 along at least the axis that is transverse the shield 12. A position of the support platform 16 may be selectively manipulated, for example, by a dial knob 52 (see FIG. 5) operatively associated with the jackscrew 50. The translating member 44 is secured to the support platform 16 and thus raises and lowers the platform. In the preferred embodiment, the jackscrew lifts and lowers the translating member 44 in one axis that is generally perpendicular to the upper and lower base members 40, 42 and the shield 12.

The translating member 44 of the adjustment means 18 preferably includes a generally L-shaped body having a first leg 46 affixed to a generally perpendicular second leg 48. The first leg 46 is a generally horizontal and planar body. The upper base member 42 is secured to the undersurface of the first leg 46; however, embodiments are contemplated that do not adapt this specific configuration of components but still provides the desired manipulation and positioning of the scanner relative to the core sample.

The second leg 48 extends upwardly from along the innermost edge of the first leg 46. A threaded bolt or or a similar fastener member 54 is illustrated in FIG. 5 as being operatively attached to an inner surface of the second leg 48 to the outer surface of the first sidewall 24 of the support platform 16. The threaded bolt 54 allows the support platform 16 to be rotationally adjusted about a center, longitudinal axis of the shield 12. Once the angle of the platform 16 is selected, the bolt 54 is then tightened to lock the platform 16 at the desired angular orientation. In the preferred embodiment, a threaded knob 54 is inserted through a threaded sleeve 55. The bolt 54 inserts into the threaded sleeve and locks in the first sidewall of the support platform 16. The threaded sleeve 55 prevents the bolt from spinning when the knob is tightened so that a secure connection is made without a need for a corresponding mechanism to secure the bolt 54. When the knob 54 is loosened, the angle of the support platform 16 relative to the longitudinal axis of the shield 12 can be adjusted. When the knob is tightened, the support platform 16 is locked in place to maintain its orientation at the desired angle.

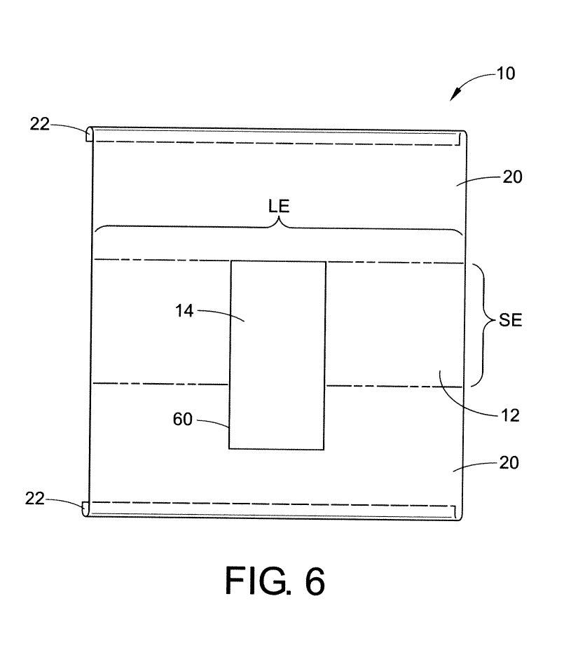

FIG. 6 is illustrative of the dimensions of the shield opening 14 relative to the shield 12. The support stand 10 of one preferred embodiment includes a shield 12 having the following dimensions: long edges LE adjacent to the supports measuring approximately 24-inches and short edges SE measuring approximately 8-inches. In one embodiment, the shield opening 14 can initiate at the first of the opposing long edges LE and extend across the shield 12 past the second of the opposing long edges. In this manner, the shield opening 12 is formed through a portion of one of the pair of supports 20. As is shown in FIG. 2, the long edge LE of the shield 12 adjacent to the rear end of the support platform 16 remains linear and continuous while the long edge of the shield adjacent to the front end of the support platform includes an inward step 60. This inward step 60 extends downwardly a height to permit movement of a butt of a handle 214 on analyzer 200 models. In other words, the handle 214 which rests on the forward sidewall 30 extends outward past that wall. The inward step 60 can measure approximately 4-inches across the support 20 and 4½-inches along that support. The shield-opening 14 includes a width of 4½-inches and a length of approximately 12-inches.

In one embodiment, each of the pair of supports 20 measures 24-inches by about 8⅛ to about 9-inches. Therefore, the support legs 20 support the shield 12 from about 7 to about 8-inches above the ground surface. In one embodiment, the folded bottom edges 22 extend approximately ½-inch upward each of the pair of supports 20.

In one embodiment, a cable can be utilized with the analyzer to allow for a remote control to take measurements. In other words, a cable (not shown) connects either to an input and control port 226 (see FIG. 2) or to a USB port proximate the display. The input 226 and any control port are situated at either the rear surface 216 or the top surface 218 of the analyzer. It is anticipated that the cable can connect to a corresponding control unit, and the measurements can be taken and viewable from a distance removed from the handheld analyzer.

More specifically, a portable computer or processing unit can be removeably housed within a cradle 300 or a similar support framework connected to the support stand 10. One contemplated portable processing unit is anticipated as being the PDA removed from the socket on the top surface 218 of the analyzer 200. FIGS. 3A and 3B illustrate the cradle 300 attached to an outer surface of one support 20 and an outer surface of the shield 12. In one embodiment, the cradle 300 may be attached to an outer surface of at least one of a support 20 and the shield 12. There is no limitation made herein to a mechanism for attaching the cradle 300 to the support stand 10; rather, any suitable connector is contemplated including, for example, mechanical fasteners, bonding adhesives, etc.

The cradle 300 illustrated in FIG. 3 includes a generally planar back support 310 for supporting a rear surface of the portable computer device. In the illustrated embodiment, the planar back support 310 includes a surface area that is greater than the surface area of the portable computer device; however, there is no limitation made herein to the dimensions. An elastic strap 320 generally urges or retains the portable computer device against the planar back support 310. The elastic strap 320 can be a closed-loop strap, similar to a rubber band, which is wrapped around both a portion of the portable computer device and a portion of the planar back support 310. To accommodate the strap 320 against the planar back support 310, the planar back support preferably extends a height beyond a plane of which the shield 12 is situated. Alternative engagement mechanisms can be used to similarly perform a function of maintaining the portable computer device in embodiments of which the cradle 300 is positioned such that the back support does not extend beyond the plane.

Alternatively or in addition to the strap 320, a floor support 330 protrudes outwardly from a lower edge of the back support 310. The portable computer device stands on and/or rests on floor support 330. When used in combination, the floor support 330 generally supports the portable computer device in an upright orientation while the elastic strap 320 holds the portable computer device against the cradle 300. The floor support 330 of the illustrated embodiment is non-continuous, however there is no limitation made herein to its overall longitudinal extent. More specifically, the floor support 330 includes a first portion generally supporting the portable computer device at a first lower corner of the device and a second portion generally supporting the portable computer device at the opposite lower corner.

A pair of sidewalls 340 extends upwardly from opposing lateral edges of the floor support 330 (or floor support portions) and outwardly from outer longitudinal edges of the back support 310. The sidewalls generally function as brackets that further support the portable computer device from any side-to-side shifts or movement.

The floor support 230 and the sidewalls 240 are generally situated perpendicular to the support 20 of the support stand 10. The support 20 is angled at approximately 120°, therefore, sidewalls 240 and the back support 210 are situated in a generally perpendicular orientation to the ground and similarly offset at approximately 120°.

A connecting structure or support 350 extends outwardly from an inner or rear surface of the back support 310 (i.e., the surface opposite that front facing surface in contact with the portable computer device). This connecting surface 350 is attached to the outer surface of the shield 12.

The portable computer device is removably positioned in the cradle 300 such that an interface of the device is made accessible and viewable to a user. Other embodiments of the cradle 300 are also contemplated,

It is anticipated that the cradle 300 be situated against the one support 20 that is in closer proximity to the port 226 on the analyzer 200 when such analyzer is supported in the support platform 16. In this manner, connecting cables can be inserted into the port 226 on the analyzer and into a corresponding port in the portable computing device so that the analyzer is operatively associated with and in communication with the computing device. Therefore, the user can selectively view and control the testing on elements from a remote location beyond the support stand 10.

The disclosure has been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A support stand for an associated handheld analyzer used to measure properties of an associated soil sample, the supported stand comprising:
a shield situated in a first plane above an associated soil sample;
a platform opening in the shield;
a support platform moveable relative to the platform opening; and,
a mechanism that moves the platform relative to the shield along an axis substantially perpendicular to the first plane;
wherein the platform supports the associated analyzer above the associated soil sample such that the associated analyzer can move relative to the associated soil sample to measure the associated soil sample.

2. The support stand of claim 1, further including:
a support extending from the shield and supporting the shield above the associated soil sample.

3. The support stand of claim 2, wherein the support includes first and second legs that extend at an angle of approximately 120° from the shield.

4. The support stand of claim 1, wherein the support platform includes a cavity receiving and supporting the associated analyzer.

5. The support stand of claim 4, wherein the support platform includes:
a first sidewall opposite a second sidewall;
an interconnecting wall extending between the first and second sidewalls; and,
a front wall;
the cavity formed by the first and second sidewalls, the interconnecting wall, and the front wall.

6. The support stand of claim 5, wherein a top edge of the front wall supports an associated handle of the associated analyzer.

7. The support stand of claim 5, further including an opening in the interconnecting wall, the opening receiving an associated front end of the associated analyzer and allowing for transmission of x-rays directed toward the associated soil sample.

8. The support stand of claim 7, wherein a top edge of the first sidewall extends beyond the shield.

9. The support stand of claim 1, wherein the mechanism that moves the platform along the vertical axis includes a jackscrew.

10. The support stand of claim 9, wherein the jackscrew includes:
a lower base member secured to a top surface of the horizontal shield; and,
an upper base member secured to an undersurface of a translating member.

11. The support stand of claim 10, wherein the translating member includes an L-shaped body having a horizontal leg affixed to a vertical leg.

12. The support stand of claim 11, wherein the vertical leg of the translating member is secured to the first leg of the support platform.

13. A portable core measurement stand for use with an associated portable scanner for measuring split-core samples in the field, comprising:
a shield with a shield opening therein, the shield including a surface supported by first and second spaced legs;
a platform moveable relative to the shield opening and having a conformation for supporting the associated portable scanner; and,
an adjustment mechanism for moving the platform relative to a first shield axis.

14. The portable core measurement stand of claim 13, wherein the adjustment mechanism includes lift and translating members operable to selectively move the scanner in substantially perpendicular directions and to allow the scanner to contact the associated split-core sample.

15. The portable core measurement stand of claim 13, wherein the stand includes open first and second ends between the legs dimensioned to receive the associated core sample between the legs.

16. The portable core measurement stand of claim 13, wherein the stand is manufactured from a material impervious to x-rays.

17. The core measurement stand of claim 13, wherein the platform includes:
a sidewall vertically extending upwardly and transversely to the horizontal surface of the shield;
an interconnecting wall extending across a cross-sectional area of the opening in the shield;
a front wall at a first end of the interconnecting wall; and,
an aperture in the interconnecting wall generally toward a second end of the interconnecting wall.

18. The core measurement stand of claim 14, wherein the aperture in the bottom wall of the platform includes a cross-sectional area approximating an associated front end of the associated scanner such that associated front end of the associated scanner can be partially received in the opening.

19. The core measurement stand of claim 14, wherein the front wall supports an associated handle of the associated scanner, a height of the front wall is less than a height between the associated front end of the associated scanner and the associated handle of the associated scanner.

20. The core measurement stand of claim 13, wherein the lift mechanism includes:
a lower base member securing the lift mechanism to the shield;
an upper base member securing the lift mechanism to the translating member; and,
a jackscrew between the lower and upper base members.

21. The core measurement stand of claim 13, wherein the translating member includes:
a vertical extending leg secured to the platform; and,
a horizontal extending leg secured to the lift mechanism;
wherein the translating member provides means for the lift mechanism to operate on the platform.

22. An instrument platform for use with an associated portable XRF analyzer, comprising:
a horizontal shield supported by downwardly extending legs;
a lifting mechanism secured to an upper surface of the horizontal shield;
a translating member secured to the lifting mechanism; and,
a platform secured to the translating member;
wherein the platform is moveable along a vertical axis through an opening in the horizontal shield; and
wherein the platform supports the associated portable XRF analyzer such that the associated portable XRF analyzer can take measurements of a soil sample situated underneath the horizontal shield.
